(19) United States
(12) Patent Application Publication
(10) Pub. No.: US 2005/0267681 A1
(43) Pub. Date: Dec. 1, 2005

(54) Route guiding device

(75) Inventor: Norihisa Yato, Gamagori-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/135,425

(22) Filed: May 24, 2005

(30) Foreign Application Priority Data
May 31, 2004 (JP) 2004-162236

(51) Int. Cl. G01C 21/34

(52) U.S. Cl. 701/210; 701/209; 340/995.19; 340/995.21

(57) ABSTRACT

In an off-road region such as river banks or mountainous region where no roads are present, route guiding is provided in a vehicle based on an off-road route computed without using map data. An objective point, passing points, and a departing point are designated and then connected therebetween using line segments to thereby compute the off-road route. The off-road route, a current position of the vehicle, or the like are displayed. The off-road route becomes unavailable when an obstructing cause that obstructs passing of the vehicle occurs. The obstructing cause includes falling rocks or inundation due to floods. When information relating to the obstructing cause is received from an information center or an information transmission device, a bypassing point is newly designated to thereby compute a route that bypasses the obstructing cause.

### CROSS REFERENCE TO RELATED APPLICATIONS

This application is based on and incorporates herein by reference Japanese Patent Application No. 2004-162236 filed on May 31, 2004.

### FIELD OF THE INVENTION

The present invention relates to a technology that guides a user to an objective point without using map data.

### BACKGROUND OF THE INVENTION

A car navigation device mounted in a vehicle is known as an example of a route guiding device that guides a user to a destination. This car navigation device computes a route from a current position (or current point) to a destination (objective point) designated by a user to thereby guide the user to the destination. Generally, this guiding route is computed based on map data. The map data includes node data and link data based on road networks. The guiding route is computed in consideration of what a traveling route on on-map roads enables the minimum distance or the minimum traveling time to a destination. Based on the guiding route computed, traveling assistance is conducted.

Further, there is a request of navigational route guiding in any manners even while an off-road traveling. Off-road regions such as river banks or mountainous regions without vehicle roads have no node data or no link data; therefore, route guiding using map data is not achievable. To deal with this issue, patent document 1 describes an off-road route guiding technology. This technology stores passed or experienced traveling tracks in an off-road region and conducts the route guiding to a destination by reading out and displaying the experienced traveling tracks stored when a relevant vehicle travels the same off-road region, without map data.
Patent Document 1: JP-2002-357431 A

However, in off-road regions, experienced traveling tracks do not continue to be available. For instance, there is a case that rocks fall on the experienced traveling tracks, or a flood inundates the traveling tracks. Off-road regions have much more temporal variations in traveling conditions than usual roads. When a user travels depending on the experienced traveling tracks, the user may realize that the tracks are not passable by finding the falling rocks or inundated regions on site. The user has to determine a route bypassing an impassable region without help of the route guiding, which means that this route guiding is less effective.

### SUMMARY OF THE INVENTION

It is an object of the present invention to provide a route guiding device that conducts dynamic route guiding even without using map data.

To achieve the above object, a route guiding device provided in a mobile object is provided with the following. A notifying unit is included for notifying a user using at least a display. A route computing unit is included for computing a first route by connecting points including a departing point, an objective point, and a passing point using at least one line segment therebetween in a designated order, wherein the passing point is designated when designating the passing point is necessary. A mobile object designating unit is included for designating at least a current position of the mobile object. A control unit is included for causing the notifying unit to visually show a positional relationship between the current position and the first route. A receiving unit is included for receiving, from an outside, obstruction information at least including an occurring point where an obstructing cause occurs, wherein the obstructing cause obstructs passing of the mobile object. A determining unit is included for determining whether re-designating a second route that bypasses the obstructing cause is necessary based on the obstruction information. Here, when re-designating the second route is determined to be necessary, the route computing unit designates a bypassing point for bypassing the obstructing cause and computes the second route by connecting the bypassing point with previous points that are used for computing the first route, using line segments between the bypassing point and the previous points.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram of a schematic structure of a navigation device according to an embodiment of the present invention;

FIG. 2 is a block diagram of a schematic structure of an information transmission device;

FIGS. 3A, 3B are views explaining off-road route guiding;

FIG. 4 is a flowchart diagram explaining a bypassing process;

FIG. 5 is a flowchart diagram explaining a timing determining process for changing a route; and

FIGS. 6A, 6B, 6C are guiding display windows for off-road routes.

### DETAILED DESCRIPTION OF THE PREFERRED EMBODIMENTS

(Explanation of Navigation Device)

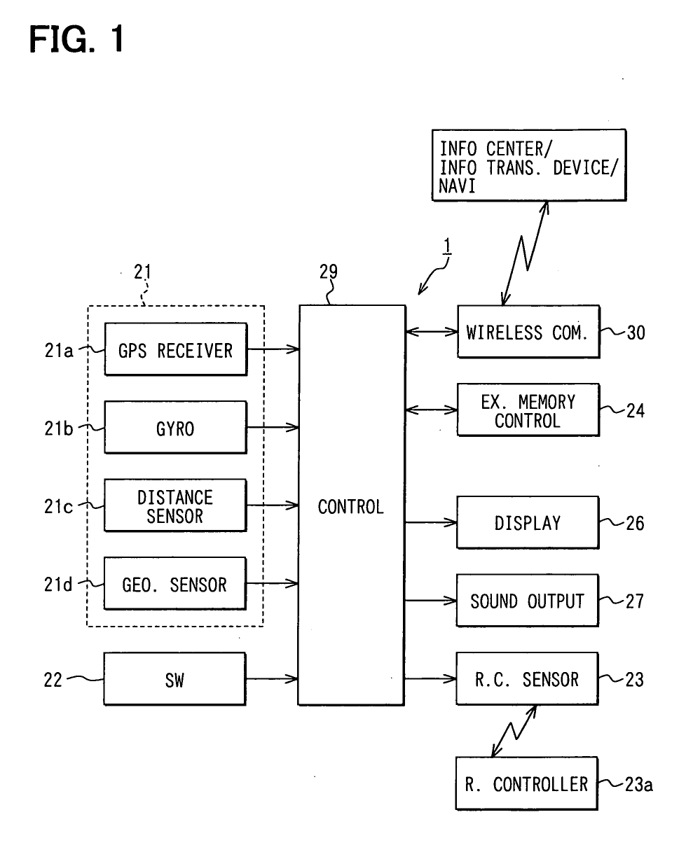

A route guiding device according to an embodiment of the present invention is directed to a navigation device. The navigation device 1 is provided in a subject vehicle as a mobile object and works as a car navigation device. As shown in FIG. 1, the navigation device 1 includes a position detector 21 for detecting a current position (or current point) of the vehicle, an operating switch group 22 for inputting various instructions by a user, a remote controller 23a for inputting various instructions similarly to the operating switch group 22, a remote control sensor 23 for inputting signals from the remote controller 23a, an external memory control device 24, a display 26 for showing various displays such as map display window or a TV window, a sound output device 27, a wireless communications terminal 30, and a control circuit 29. The control circuit 29 executes various processing based on inputs from the position detector 21, the operating switch group 22, the remote controller 23a, and the external memory control device 24; further, the control circuit 29 controls the position detector 21, the operating switch group 22, the remote control sensor 23, the external memory control device 24, the display 26, the sound output device 27, and the wireless communications terminal 30.

The position detector 21 works as a mobile object (vehicle) designating unit for designating or specifying a state of the vehicle. The position detector 21 includes a GPS receiver 21a for detecting a current position of the vehicle by receiving radio-waves from satellites for GPS (Global Positioning System) via a GPS antenna, a gyroscope 21b for detecting a rotational movement acting on the vehicle, a distance sensor 21c for detecting a traveling distance of the vehicle, and a geomagnetic sensor 21d for detecting an advancing direction from geomagnetism. These sensors or the like 21a to 21d have individual different natured errors, so they are used while being mutually complemented. Depending on accuracy requirements, only a part of the sensors or the like 21a to 21d can be used; further, a rotational sensor of steering or a wheel sensor of each following wheel can be used.

The operating switch group 22 is integrated with the display 26 to include a touch panel provided on a display screen or a mechanical switch provided around the display screen. The touch panel and the display 26 are laminated as a unit. The touch panel includes a pressure sensitive type, an electromagnetic induction type, an electrostatic capacity type, or a combination of the foregoing.

The external memory control device 24 conducts a control of data reading from or, if possible, data writing on an external storage medium such as a DVD-ROM, a HDD, or a memory card. The external storage medium stores information that includes road data as network data, map data including map-matching data for enhancing accuracy in designating positions, landmark data, or programs for activating the navigation device 1. The navigation device 1 of this embodiment can conduct route computing and route guiding without using map data, which will be described later. Namely, when the vehicle or the navigation device 1 is present on roads, route guiding is conducted based on a route computed using map data. When the vehicle or the navigation device 1 travels in an off-road region such as river banks or mountainous regions, route guiding is conducted based on a guiding route computed without map data.

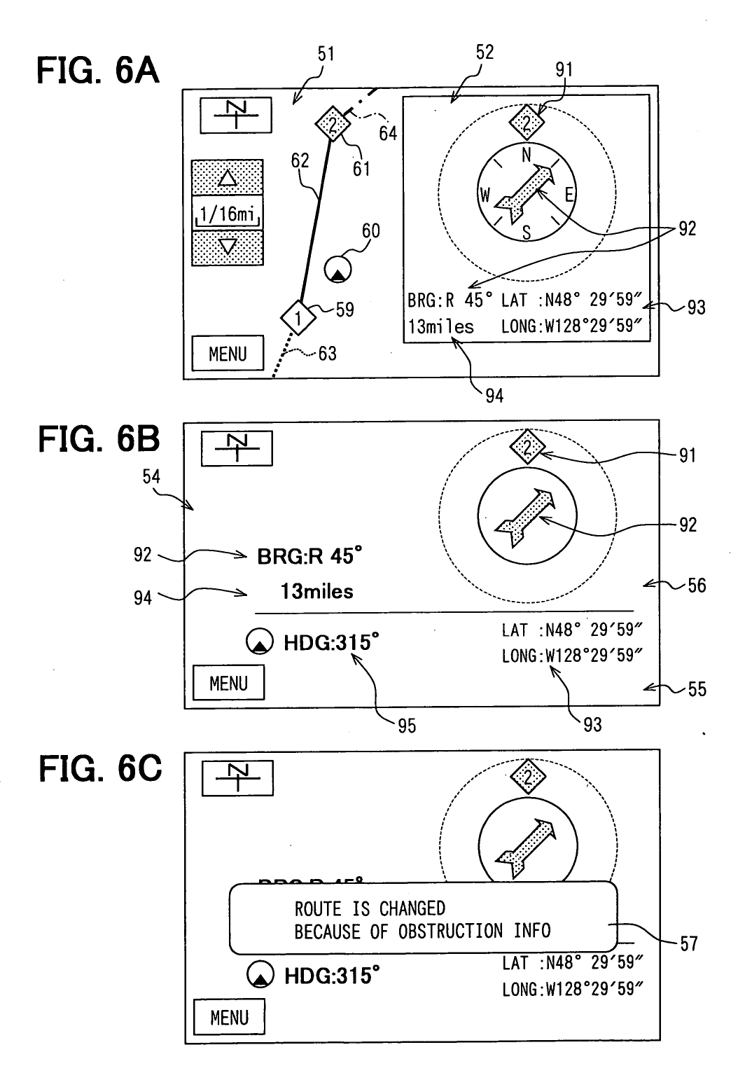

The display 26 is a color display to include any one of a liquid crystal display, a plasma display, and a CRT. The display window of the display 26 displays computed routes and current positions of the vehicle detected by the position detector 21. Further, in route guiding based on a route computed using map data, the display 26 shows additional data including a guiding route to a destination (or objective point) based on map data, names, landmarks, or facility marks. In contrast, in route guiding based on a route computed without using map data, the display 26 shows a route or a compass as shown in FIGS. 6A to 6C, which will be explained later in detail.

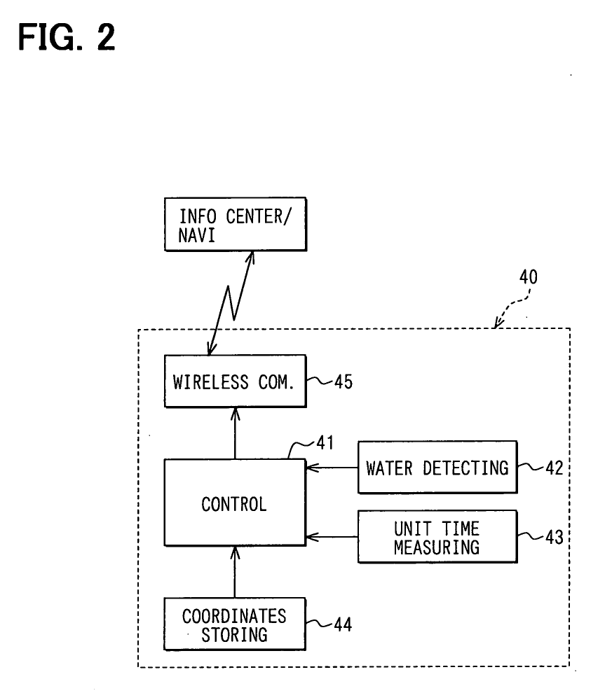

The wireless communications terminal 30 communicates with an external information center, an information transmission device 40 shown in FIG. 2, or a remote comparable navigation device 1.

The control circuit 29 mainly includes a micro-processor that consists of a CPU, a ROM, a RAM, an I/O, and a bus line connecting the foregoing components. The control circuit 29 conducts based on programs stored in the ROM or the like various controls such as a designating process for passing points or destinations, a route computing process, or a route guiding process. Further, the control circuit 29 computes a current position of the vehicle as a set of an advancing direction (or bearing) and coordinates based on detection signals from the position detector 21 to thereby use the current position computed for the route guiding process.

(Explanation of Information Transmission Device)

The information transmission device 40 will be explained with reference to FIG. 2. The information transmission device 40 is placed, for instance, in a location such as a valley, which tends to be impassable when raining, for automatically detecting and outwardly transmitting rainfalls.

The information transmission device 40 includes a control unit 41 that controls the whole of the information transmission device 40, a water level detecting unit 42 for detecting a water level, a unit time measuring unit 43 for measuring a unit time used for measuring rainfalls per a unit time, a setting location storing unit 44 that stores coordinates (longitude and latitude) of a setting location of the information transmission device 40, and a wireless communications terminal 45 that transmits information to an external information center or a navigation device 1.

The unit time measuring unit 43 measures, for instance, a unit time such as one minute, or five minutes and then sends to the control unit 41 information that a unit time elapses. Each time receiving the information of the unit time elapsing, the control unit 41 obtains water level information at this moment from the water level detecting unit 42 to thereby compute a rainfall per a unit time based on a difference from water information previously obtained and the water information currently obtained. If necessary, a unit time can be changed to 1 hour, 2 hours, or 24 hours that is a relatively long unit time. The rainfall thus obtained is transmitted to the information center or surrounding vehicles via the wireless communications terminal 45, along with the setting location coordinates stored in the setting location storing unit 44. This transmission can be continually conducted, or conducted only when the rainfall exceeds a given value. Further, the transmission can be conducted as a reference, regardless of whether a route is changed or not.

When the navigation device 1 receives this information, the navigation device 1 determines whether the vehicle can pass the relevant location by comparing a height of the vehicle with the water level information. Here, transmission of the information to the information center is conducted via the wireless communications line; however, it can be conducted via a wired communications line. Here, the information transmission device 40 that automatically transmits rainfalls to an outside is explained above; however, a device having the following information can be used.
Device that is disposed in a location where rocks tend to fall and sends a detection and warning of falling rocks
Device that is disposed in a river bank and sends a detection and warning of an increased water level
Device that is disposed in a location which tends to have mudslides and detects a detection or warning of mud slides

(Explanation of Operation of Navigation Device)

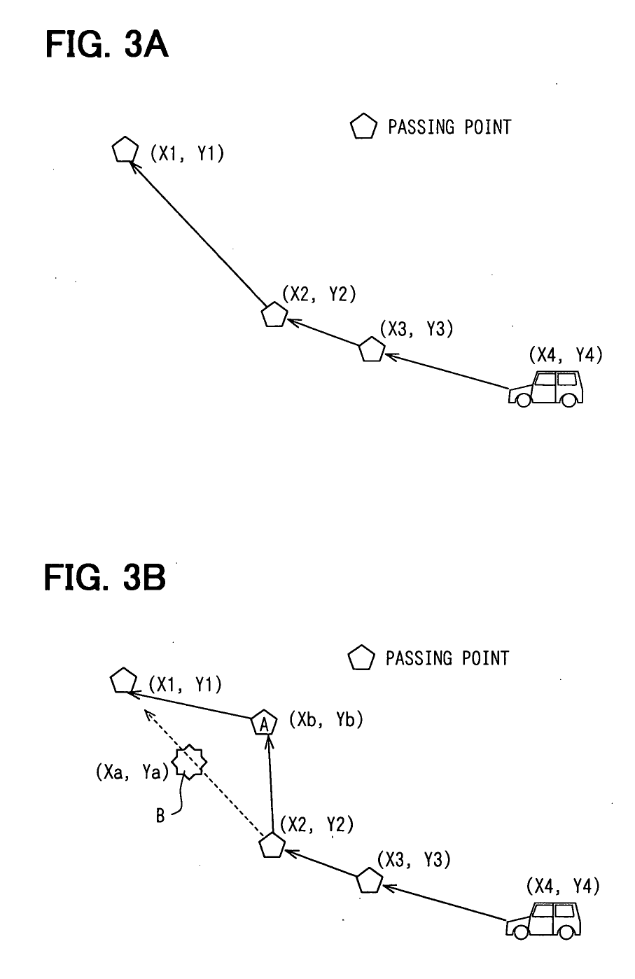

At first, operations of route computing and route guiding will be explained. As explained above, when traveling on roads, the navigation device 1 conducts route guiding based on a route computed with using map data. This route computing or route guiding are known technologies, so explanation for them is deleted. In contrast, when traveling in an off-road region where no on-map roads are available, the navigation device 1 conducts route guiding based on a route computed without using map data. In detail, as shown in FIG. 3A, a departing point, a destination, and a passing point (if necessary) are designated beforehand; further, a distance or a direction to a next passing point or a destination is provided to a user. For instance, in FIG. 3A, a destination (X1, Y1), two passing points (X2, Y2), (X3, Y3), and a departing point (X4, Y4) are designated. In detail, the following designating method can be used. Coordinates are beforehand obtained from a paper map and inputted. Coordinates are beforehand obtained from a previously designated mountainous course for off-road traveling. Coordinates are beforehand obtained from a passed or experienced traveling track that the vehicle traveled in the past or that another vehicle traveled in the past. Coordinates can be inputted in longitude and latitude. Further, the departing point (X4, Y4) can be a current position, so a current position detected by the position detector 21 can be directly designated.

An order of passing points can be separately designated after the destination and the passing points are designated. Otherwise, an automatic designating method can be used. Namely, points are designated in an order of a destination→a passing point closest to the destination→a passing point next closest to the destination→ . . . →a passing point farthest from the destination, so that the points are automatically designated in a passing order. Further, thus designated order can be modified afterward.

When the passing order is determined once, the destination and the passing point, the passing points, the passing point and the departing point are respectively connected with each other using line segments to thereby compute a route (off-road route) without using map data. This off-road route is shown in the display 26 along with a current position of the vehicle, so a positional relationship between the off-road route and the current position can be visually recognized. This enables the user or the driver to be guided while seeing the contents in the display window in the display 26.

Examples of guiding display windows of off-road routes will be explained with reference to FIGS. 6A to 6C. In FIG. 6A, the left half of the window is a first display area 51 while the right half is a second display area 52. The first display area 51 includes a direction mark, a scroll button, a menu button, an off-road route, and a current position mark 60. The off-road route includes an immediately-previously-guided passing point 59, a currently-guided passing point 61, a line segment 62 connecting both the passing points 59, 61, and other line segments 63, 64. The line segment 63 connects the immediately-previously-guided passing point 59 and a previously-guided passing point. The line segment 64 connects the currently-guided passing point 61 and a next-guided passing point. Further, the line segment 62 is different from the other line segments 63, 64 in a color, a width, or a kind, so the line segment 62 can be differentiated from the other line segments 63, 64. This enables the user to clearly recognize the passing point 61 that is a target location at present.

The second display area 52 schematically shows the next passing point 91 and an advancing direction of the vehicle (vehicle's bearing 92) with respect to the point 91 on a direction sign patterning a compass, while numerically showing a vehicle's location 93 (longitude and latitude), the vehicle's bearing 92, and a distance 94 to the next passing point. Here, “BRG: R45°” represents 45° right-handed or clockwise on the basis of the north, i.e., 45° to east from the north.

A second example is shown in FIG. 6B. Here, the contents shown in the second display window 52 in FIG. 6A is enlarged instead of schematically showing the off-road route. A left upper area of the display is a passing point information display area 54; an right upper area is a compass display area 56; and, a lower area is a vehicle information display area 55.

The passing point information display area 54 shows the vehicle's bearing 92 (BRG: R 45°) with respect to the next passing point 92 and the distance 94 (13 miles) to the next passing point. The compass display area 56 visually shows a relationship between the point of the next passing point 91 and the vehicle's bearing 92. The vehicle information display area 55 numerically shows the vehicle's bearing (HDG: 315°) 95 with respect to the north, and the vehicle's location 93.

This off-road route thus computed, however, becomes unavailable or improper when an obstructing cause such as falling rocks or inundation due to a river flood occurs.

The navigation device 1 of this embodiment solves this problem. Namely, the navigation device 1 receives information from the information center, the information transmission device 40, or another remote navigation device 1 via the terminal 30 to thereby determine whether re-designating a route bypassing the obstructing cause is necessary or not based on the information received. For instance, as shown in FIG. 3B, when an obstructing cause B occurs in a location (Xa, Ya) on a line segment between a destination (X1, Y1) and a passing point (X2, Y2) closest to the destination, a bypassing point A (Xb, Yb) is designated. A route that is able to bypass the location (Xa, Ya) of the obstructing cause B is computed by connecting the destination (X1, Y1) and the bypassing point (Xb, Yb), and the bypassing point (Xb, Yb) and the passing point (X2, Y2) using line segments. This bypassing route re-computed is shown in the display 26.

Here, the bypassing point (Xb, Yb) can be designated to be located in a given distance from the line segment between the destination (X1, Y1) and the passing point (X2, Y2) on the basis of the location (Xa, Ya) of the obstructing cause B. This given distance will be explained later.

When this bypassing route is designated, a route change guiding display 57 is shown in the foreground in the display 26 while overlapping with the display shown in FIG. 6B, as shown in FIG. 6C. This route change guiding display 57 includes a notification of “route is changed because of obstruction information.” Further, a comparable sound notification can be outputted via the sound output device 27 along with the above visual notification in the display 26 or without displaying the above visual notification. As a warning function, the sound notification is more effective in notifying a user than the visual notification, so at least sound notification should be conducted.

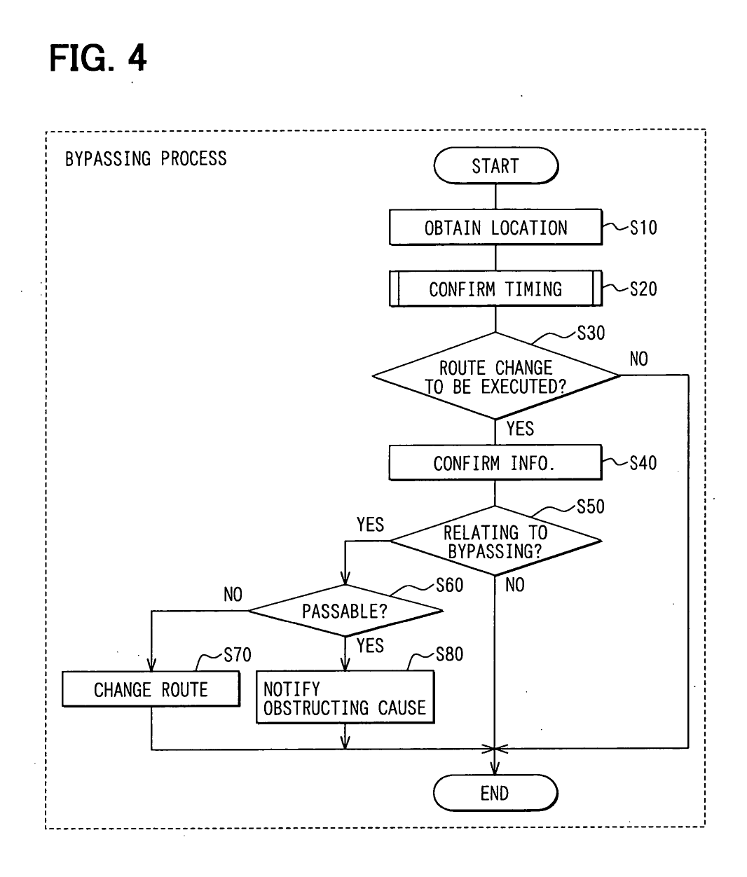

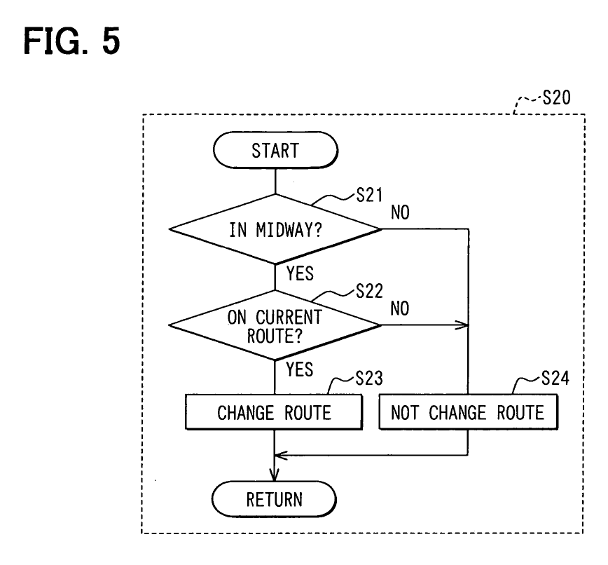

Next, a bypassing process for computing a route bypassing an obstructing cause will be explained with reference to FIGS. 4, 5. This bypassing process is executed by the control circuit 29 with given time intervals or at a timing when obstructing information is received, after a route is computed without using map data and a route guiding process starts. Further, this route guiding process takes place along with the bypassing process.

Furthermore, in a receiving process (not shown), when obstructing information is received from the external information center, the information transmission device 40, or another remote navigation device 1, the obstructing information received is temporarily stored in the RAM. This obstructing information includes an occurring location, a kind, an obstructing degree, or the like of the obstructing cause. For instance, when the obstructing information is received from the information transmission device 40 that detects rainfalls, the obstructing information includes a setting location, information that the obstruction information relates to a rainfall, or a rainfall (unit time rainfall or accumulated rainfall).

As the process starts, at Step S10, the control circuit 29 obtains current position information including latitude and longitude based on the signal from the position detector 21. At Step S20, it is determined whether it is a route change timing.

This route change timing confirming process will be explained with reference to FIG. 5. At Step S21, it is determined whether an obstructing point is located in a midway to the next passing point. For instance, a line with a given width to the next passing point is drawn; then, it is determined whether the obstructing point is included in this line. Here, the given width can be set by the user or previously set.

When the obstructing point is included in a midway to the next passing point (S21: YES), it is then determined whether the obstructing point is located on a current route at Step S22. A method for determining is similar to that at Step S21.

When the obstructing point is located on the current route (S22: YES), a result that change of the current route is necessary is stored at Step S23 and the sequence returns to Step S30 in FIG. 4. In contrast, when the obstructing point is not included in a midway to the next passing point (S21: NO) or when the obstructing point is not located on the current route (S22: NO), a result that change of the current route is not necessary is stored at Step S24 and the sequence returns to Step S30 in FIG. 4.

At Step S30 in FIG. 4, it is determined whether a route change should be executed based on the result at Step S20 (or S23, S24). Namely, when the route change is not necessary (S30: NO), the process ends. When the route change (S30: YES) is necessary, the sequence goes to Step S40, where information relating to a kind or degree of the obstructing cause is confirmed. Then, at Step S50, it is determined whether the information confirmed relates to bypassing.

When the information confirmed does not relate to bypassing (S50: NO), the process ends. When the information confirmed relates to bypassing (S50: YES), it is determined whether the current route is passable at Step S60. When it is impassable (S60: NO), a route change is executed at Step S70. When it is passable (S60: YES), a route change is not executed and the relevant obstructing cause is notified at Step S80. After process at Steps S70, S80 ends, the process ends.

The determination of whether the information confirmed relates to bypassing at Step S50, or the determination of whether the current route is passable at Step S60 can be performed with reference to a bypassing table. This bypassing table presents whether information relates to an obstructing cause; further, when information relates to an obstructing cause, the bypassing table indicates a degree that the obstructing cause disables the vehicle to pass through. Further, the two determinations at Steps S50, S60 vary depending on a type of the vehicle where the navigation device 1 is provided. For instance, when the vehicle is an off-road vehicle that is structurally prepared for traveling on off-road regions, a slightly inundated region can be passable for this off-road vehicle. However, when an inundated degree becomes deep, this region is impassable. Suppose that a case that falling rocks or stones are on a route. In this case, even if this route is physically or mechanically passable for the vehicle, it is advisable impassable from a safety point of view because of potential additional rocks to fall. Thus, even when an obstructing cause is present, whether it is passable or not varies depending on a degree or a kind of a relevant obstructing cause, or a kind of a relevant vehicle (or mobile object) that is to pass the obstructing cause. Therefore, whether it is passable or not can be properly determined based on a degree or a kind of the obstructing cause, further in consideration of a subject vehicle. For instance, when a certain vehicle is lower than an off-road vehicle in a vehicle height, an inundated water level enabling the certain vehicle to pass is lower than that enabling the above off-road vehicle to pass. Consequently, a bypassing table should be prepared for each of kinds of vehicles.

Further, the information relating to an obstructing cause in a bypassing table can be set by a user. For instance, even when an obstructing cause is a shallow water level that is mechanically passable, a user may dislike passing this cause by preventing a vehicle from becoming dirty. Further, information that does not relate to an obstructing cause includes the following. Namely, even when a mountainous region has snow, a vehicle provided with snow tires for traveling snowy roads can manage to pass this cause.

In the route change at Step S70, at first, a bypassing point (Xb, Yb) for bypassing the obstructing cause B is designated, as explained with reference to FIG. 3B. Then, the bypassing point is connected with the previously-designated points using line segments, so that a bypassing route bypassing the obstructing cause B can be computed. As explained above, the bypassing point (Xb, Yb) can be designated to be located in a given distance from the line segment between the destination (X1, Y1) and the passing point (X2, Y2) on the basis of the location (Xa, Ya) of the obstructing cause B. This given distance is preferably determined depending on a degree or a kind of an obstructing cause. If a given distance is set uniformly regardless of kinds or degrees of obstructing causes, this given distance needs to become a relatively far point that may be unnecessarily useless. For instance, suppose a case that a route is on a river bank. Here, when the obstructing cause is inundation over the river bank, a bypassing point must be designated at a point excluding the river bank. However, when the cause is a fallen tree, a bypassing point can be successfully set at a point excluding this fallen tree. Thus, since a degree or a kind of an obstructing cause varies a width or a region that is impassable and needs to be bypassed, the above given distance for setting the bypassing point should be determined based on the degree or the kind of the obstructing cause. In detail, given distances corresponding to kinds or degrees of obstructing causes can be included in a table, so that a proper given distance can be selected based on the table. Thus, designating a bypassing point in correspondence with a kind or a degree of an obstructing cause enables re-designating a route to be properly conducted.

Further, regarding the notification of the obstructing cause at Step S80, not only a kind but also a degree of the obstructing cause is preferably notified. For instance, suppose that a vehicle can pass through a certain inundation. Here, a driver or a user may request that the vehicle takes a route bypassing the certain inundation. When the information including a water level in the certain inundation is notified, a final determination can be conducted by the driver. Here, the notification of the obstructing cause is shown in the foreground of the display while overlapping with the previously-displayed information or a comparable guiding sound can be additionally or alternatively outputted via the sound output device 27.

(Others)

(1) The navigation device 1 of the embodiment is mounted in a vehicle. However, the navigation device 1 can be carried by a user or a person. Suppose a user walks off-road regions around mountains with the navigation device 1. When an obstructing cause such as an inundated region or a rock-falling region is present on a route that the user walks, it is favorable or convenient that the user can take a changed route bypassing the obstructing cause.

(2) The navigation device 1 of the embodiment is provided with map data for conventional route guiding on on-map roads. However, if this device 1 is dedicated for off-road traveling, the navigation device 1 can dispose the map data.

(3) The navigation device 1 of the embodiment receives obstructing information from another remote navigation device 1. When the information transmission device 40 or the information center is present, the obstructing information can be obtained from these information sources. However, there is a case or region where no information transmission device is present or available. Here, a driver having a certain navigation device 1 may find an obstructing cause for the first time. This navigation device 1 is favorably designed to have a transmitting unit for sending obstructing information relating to the obstructing cause that this navigation device 1 encounters. Here, the driver or the like inputs the obstructing cause and its obstructing degree by operating the operating switch group 22 or the like; the position detecting unit 21 detects a current position of the navigation device 1; further, obstructing information is produced based on the obstructing cause and its obstructing degree inputted and the current position detected; finally, the obstructing information produced is sent to the information center or another remote navigation device 1 via the wireless communications terminal 30. Thus, real time information can become available.

Furthermore, this navigation device 1 that receives obstructing information to thereby conduct route guiding sends obstructing information. However, a given device that is dedicated for collecting obstructing information can be provided. For instance, a vehicle that manages forest regions or goes on patrol there can be provided with the given device dedicated for sending obstructing information. In this case, a patrolling person can send information that is collected using the given device. Further, the given device can be provided in an airplane or a helicopter for collecting obstructing information.

It will be obvious to those skilled in the art that various changes may be made in the above-described embodiments of the present invention. However, the scope of the present invention should be determined by the following claims.

1. A route guiding device provided in a mobile object, the device comprising:
a notifying unit that notifies a user using at least a display;
a route computing unit that computes a first route by connecting points including a departing point, an objective point, and a passing point using at least one line segment therebetween in a designated order, wherein the passing point is designated when designating the passing point is necessary;
a mobile object designating unit that designates at least a current position of the mobile object;
a control unit that causes the notifying unit to visually show a positional relationship between the current position and the first route;
a receiving unit that receives, from an outside, obstruction information at least including an occurring point where an obstructing cause occurs, wherein the obstructing cause obstructs passing of the mobile object; and
a determining unit that determines whether re-designating a second route that bypasses the obstructing cause is necessary based on the obstruction information,
wherein, when re-designating the second route is determined to be necessary, the route computing unit designates a bypassing point for bypassing the obstructing cause and computes the second route by connecting the bypassing point with previous points that are used for computing the first route, using line segments between the bypassing point and the previous points.

2. The route guiding device of claim 1,
wherein, when the second route that is able to bypass the obstructing cause is computed, the control unit displays, using the notifying unit, info that the second route that is able to by pass the obstructing cause is computed.

3. The route guiding device of claim 1,
wherein the notifying unit notifies the user using a sound in addition to the display, and
wherein, when the second route that is able to bypass the obstructing cause is computed, the control unit causes the notifying unit to notify info that the second route that is able to by pass the obstructing cause is computed, by using at least the sound.

4. The route guiding device of claim 1,
wherein the receiving unit additionally receives a kind of the obstructing cause and an obstructing degree when the obstructing degree is available, and
wherein the determining unit determines whether re-designating the second route is necessary based on the occurring point, the kind of the obstructing cause, and the obstructing degree.

5. The route guiding device of claim 4, further comprising:
a storing unit that stores a bypassing table that provides whether bypassing is necessary or not based on the kind of the obstructing cause and the obstructing degree when the obstructing degree is available,
wherein the determining unit determines whether re-designating the second route is necessary based on the bypassing table.

6. The route guiding device of claim 4,
wherein the route computing unit designates a certain point as the bypassing point based on the kind of the obstructing cause and the obstructing degree when the obstructing degree is available, wherein the certain point is located in a certain distance from the occurring point.

7. The route guiding device of claim 4,
wherein the control unit causes the notifying unit to notify the kind of the obstructing cause and the obstructing degree when the obstructing degree is available.

8. The route guiding device of claim 1, further comprising:
an accepting unit that accepts an operation by the user; and
a transmitting unit that generates obstruction information relating to the obstructing cause based on the operation accepted to then send the obstruction information generated to the outside.

9. A computer program product in a computer-readable medium for use in a route guiding device provided in a mobile object, wherein the device includes:
a notifying unit that notifies a user using at least a display;
a route computing unit that computes a first route by connecting points including a departing point, an objective point, and a passing point using at least one line segment therebetween in a designated order, wherein the passing point is designated when designating the passing point is necessary;
a mobile object designating unit that designates at least a current position of the mobile object; and
a receiving unit that receives, from an outside, obstruction information at least including an occurring point where an obstructing cause occurs, wherein the obstructing cause obstructs passing of the mobile object,
the computer program product comprising:
instructions for causing the notifying unit to visually show a positional relationship between the current position and the first route;
instructions for determining whether re-designating a second route that bypasses the obstructing cause is necessary based on the obstruction information; and
instructions for designating a bypassing point for bypassing the obstructing cause to compute the second route by connecting the bypassing point with previous points that are used for computing the first route, using line segments between the bypassing point and the previous points, when re-designating the second route is determined to be necessary.

10. A method used in a route guiding device provided in a mobile object, wherein the device includes:
a notifying unit that notifies a user using at least a display;
a route computing unit that computes a first route by connecting points including a departing point, an objective point, and a passing point using at least one line segment therebetween in a designated order, wherein the passing point is designated when designating the passing point is necessary;
a mobile object designating unit that designates at least a current position of the mobile object; and
a receiving unit that receives, from an outside, obstruction information at least including an occurring point where an obstructing cause occurs, wherein the obstructing cause obstructs passing of the mobile object,
the method comprising steps of:
causing the notifying unit to visually show a positional relationship between the current position and the first route;
determining whether re-designating a second route that bypasses the obstructing cause is necessary based on the obstruction information; and
designating a bypassing point for bypassing the obstructing cause to compute the second route by connecting the bypassing point with previous points that are used for computing the first route, using line segments between the bypassing point and the previous points, when re-designating the second route is determined to be necessary.
